(19) United States
(12) Patent Application Publication
(10) Pub. No.: US 2020/0270490 A1
(43) Pub. Date: Aug. 27, 2020

(54) Adhesive Composition, Adhesive and Adhesive Sheet

(71) Applicant: SOKEN CHEMICAL & ENGINGEERING Co., Ltd., Tokyo (JP)

(72) Inventors: Akemi SHIRAISHI, Saitama (JP); Seiji YOKOKURA, Saitama (JP)

(21) Appl. No.: 15/733,038

(22) PCT Filed: Oct. 19, 2018
(86) PCT No.: PCT/JP2018/038971

§ 371 Date: Apr. 24, 2020

(30) Foreign Application Priority Data
Nov. 6, 2017 (JP) 2017-213744

(51) Int. Cl. C09J 133/08; C09J 133/10; C09J 133/26; C09J 123/26; C09J 7/24; C09J 133/06; C09J 133/02

(52) U.S. Cl. CPC C09J 133/08; C09J 133/10; C09J 133/26; C09J 123/26; C08K 5/1515; C09J 133/068; C09J 133/02; C09J 2203/10; C09J 2423/006; C09J 7/241

(57) ABSTRACT

An adhesive composition, an adhesive, and an adhesive sheet capable of exhibiting good adhesion performance even on a low-polarity adherend are provided. The adhesive composition according to the present disclosure includes a (meth) acrylic polymer with a solubility parameter of 10.0 (cal/cm³)^{0.5} or more according to the Fedors method and a modified polyolefin.

### CROSS-REFERENCE TO RELATED APPLICATION

This patent application claims priority from PCT Patent Application No. PCT/JP2018/038971 filed Oct. 19, 2018, which claims priority from Japanese Patent Application No. JP2017-213744 filed Nov. 6, 2017. Each of these patent applications are herein incorporated by reference in its/their entirety.

### TECHNICAL FIELD

The present disclosure relates to an adhesive composition, an adhesive, and an adhesive sheet.

### BACKGROUND

Many studies have been conducted to improve the performance of adhesives. In particular, it is desirable that the adhesive exhibits high adhesion performance regardless of the properties of adherends. However, conventional (meta) acrylic adhesives are known to be difficult to achieve good adhesion performance for low-polarity adherends, such as polyolefin adherends.

### SUMMARY

### Problems to be Solved

An object of the present disclosure is to provide an adhesive composition, an adhesive, and an adhesive sheet capable of exhibiting good adhesion performance even on a low-polarity adherend.

### Means for Solving the Problems

The present inventors have done a keen study to solve the above problems. As a result, the present inventors have found that by using a (meth) acrylic polymer having a relatively high solubility parameter and a modified polyolefin in combination, it is possible to achieve good adhesion performance even on a low-polarity adherend.

Aspects of the present disclosure are, for example, as follows.

[1] An adhesive composition including a (meth) acrylic polymer with a solubility parameter of 10.0 (cal/cm³)^{0.5} or more by the Fedors method and a modified polyolefin.

[2] The adhesive composition according to [1], wherein the (meth) acrylic polymer is obtained by copolymerizing a monomer mixture including a first monomer and a second monomer. The first monomer has a solubility parameter of 9.8 (cal/cm³)^{0.5} or more by the Fedors method at the time of forming a homopolymer and contains no crosslinkable functional group. The second monomer contains a crosslinkable functional group.

[3] The adhesive composition according to [2], wherein the second monomer contains nitrogen.

[4] The adhesive composition according to any one of [1] to [3], wherein the modified polyolefin is a polyolefin containing carboxylic acid.

[5] The adhesive composition according to any one of [1] to [4] further containing an epoxy-based curing agent.

[6] An adhesive formed from the adhesive composition according to any of [1] to [5].

[7] An adhesive sheet comprising an adhesive layer formed on at least one surface of the substrate by the adhesive composition according to any of [1] to [5].

[8] The adhesive sheet according to [7], wherein the substrate includes a polyolefin.

### Effects

According to the present disclosure, it is possible to provide an adhesive composition, an adhesive, and an adhesive sheet capable of exhibiting good adhesion performance even on a low-polarity adherend.

### DETAILED DESCRIPTION

Hereinafter, an adhesive composition, an adhesive, and an adhesive sheet according to one aspect of the present disclosure will be described.

It is to be noted that, in the present specification, “polymer” is used to mean homopolymers and copolymers are included, and “polymerization” is used to mean homopolymerization and copolymerization are included. Also, a compound represented by an expression (i) (i is the formula number) simply means a “compound (i)”. Further, in the present specification, (meth) acrylic means acrylic or methacrylic, (meth) acrylate means acrylate or methacrylate, and (meth) acrylo means acrylo or methacrylo.

### Adhesive Composition

The adhesive composition according to one aspect of the present disclosure includes a (meth) acrylic polymer and a modified polyolefin. This (meth) acrylic polymer has a solubility parameter of 10.0 (cal/cm³)^{0.5} or more by the Fedors method. As described above, the present inventors have found that by adopting such a configuration, it is possible to achieve good adhesion performance even on a low-polarity adherend.

Although the principle is not exactly clear, the present inventors speculate as follows. That is, the (meth) acrylic polymer satisfying the above conditions has a relatively high polarity. In contrast, the modified polyolefin has relatively low polarity. Due to such a polarity difference, the modified polyolefin with relatively low polarity tends to be unevenly distributed at the interface of the adhesive layer. Thereby, good adhesion performance can be exhibited even on a low-polarity adherend.

### (Meth) Acrylic Polymer

As described above, the (meth) acrylic polymer has a solubility parameter of 10.0 (cal/cm³)^{0.5} or more by the Fedors method. There is no particular restriction on the monomer configuration for realizing such (meth) acrylic polymer, but for example, the polymer is obtained by copolymerizing a monomer mixture including a first monomer and a second monomer. The first monomer has a solubility parameter of 9.8 (cal/cm³)^{0.5} or more by the Fedors method at the time of forming a homopolymer and contains no crosslinkable functional group. The second monomer contains a crosslinkable functional group. It is to be noted that this monomer mixture may further include one or more kinds of monomers in addition to the first and the second monomer.

Here, the “crosslinkable functional group” means a functional group that can be used for linking between polymers by a crosslinking reaction, and as the specific examples thereof, a hydroxyl group, a carboxy group, an acid anhydride group, a phosphate group, a sulfate group, an amino group, an amide group, a cyano group, a thiol group, and a silyl group are exemplified.

This polymer may be synthesized by a conventional radical polymerization method, or it may be synthesized by a living radical polymerization method. The weight-average molecular weight (Mw) of this polymer measured by the gel permeation chromatography (GPC) method is, for example, 100,000 to 3,000,000, preferably 150,000 to 2,000,000, more preferably 200,000 to 1,000,000. The molecular weight distribution (Mw/Mn) of this polymer by the GPC method is, for example, 30.0 or less, preferably 25.0 or less, more preferably 20.0 or less.

This polymer may be a random polymer or a block polymer. This polymer may be, for example, a (meth) acrylic random polymer or a (meth) acrylic block polymer.

### The First Monomer

The first monomer has, for example, a solubility parameter of 9.8 (cal/cm³)^{0.5} or more by the Fedors method when a homopolymer is formed. The first monomer may have a polar group other than the crosslinkable functional group. As such polar group, for example, an alkoxy group and an ether group (ether bond) are exemplified. As the alkoxy group, those having a carbon number of 1 to 4 are preferable, for example, a methoxy group or an ethoxy group is exemplified.

As specific examples of the first monomer, those shown in the following Table 1 are exemplified. It is to be noted that, about some of these specific examples, the solubility parameter by the Fedors method when forming a homopolymer is also described.

TABLE 1

| Monomer | Solubility parameter (cal/cm³)^{0.5} |
|---|---|
| methoxyethyl acrylate | 10.2 |
| methyl acrylate | 10.6 |
| ethoxydiethylene glycol acrylate | 9.8 |
| ethyl acrylate | 10.2 |
| methyl methacrylate | 9.9 |
| methoxytriethylene glycol acrylate | 9.8 |
| (2-methyl-2-ethyl-1,3-dioxolane-4- | 10.5 |
| yl) methyl acrylate | |
| (3-ethyloxetan-3-yl) methyl | 10.3 |
| methacrylate | |
| cyclic trimethylolpropane formal | 10.7 |
| acrylate | |

One type of the first monomer may be used alone, or two or more types may be used in combination. The content of the first monomer is, for example, 30 mass % or more, preferably 30 mass % to 90 mass %, more preferably 40 mass % to 80 mass %, with respect to 100 parts by mass of the polymer.

### The Second Monomer

The second monomer is, for example, a monomer containing a crosslinkable functional group. As the crosslinkable functional group, for example, a hydroxyl group, a carboxy group, an acid anhydride group, a phosphate group, a sulfate group, an amino group, an amide group, a cyano group, a thiol group, and a silyl group are exemplified. These may be in linear, branched or cyclic form.

From the viewpoint of further improving the adhesion performance of the adhesive composition, as the second monomer, for example, a nitrogen-containing monomer is exemplified. Among those mentioned above, particularly, an amino group-containing monomer, an amide group-containing monomer, and a nitrogen-based heterocyclic ring-containing monomer are exemplified.

As the hydroxy group-containing monomer, for example, hydroxy group-containing (meth) acrylate is exemplified, and specifically, hydroxyalkyl (meth) acrylates such as 2-hydroxyethyl (meth) acrylate, 3-hydroxypropyl (meth) acrylate, 4-hydroxybutyl (meth) acrylate, 6-hydroxyhexyl (meth) acrylate, 8-hydroxyoctyl (meth) acrylate and the like are exemplified. The carbon number of the alkyl group in the hydroxyalkyl (meth) acrylate is usually 2 to 8, preferably 2 to 6.

As the carboxy group-containing monomer, for example, β-carboxyethyl (meth) acrylate, 5-carboxypentyl (meth) acrylate, mono (meth) acryloyloxyethyl succinate, ω-carboxypolycaprolactone mono (meth) acrylate, acrylic acid, methacrylic acid, itaconic acid, crotonic acid, fumaric acid, maleic acid are exemplified. As the acid anhydride group-containing monomer, for example, maleic anhydride is exemplified. As the phosphate group-containing monomer, a (meth) acrylic monomer having a phosphate group in a side chain is exemplified, and as the sulfate group-containing monomer, a (meth) acrylic monomer having a sulfate group in a side chain is exemplified.

As the amino group-containing monomer, for example, amino group-containing (meth) acrylates such as dimethylaminoethyl (meth) acrylate, diethylaminoethyl (meth) acrylate and the like are exemplified. As the specific examples of the amino group-containing monomer, tert-butylaminoethyl methacrylate (TBAEMA), dimethylaminoethyl methacrylate (DMAEMA; DM), diethylaminoethyl methacrylate (DEAEMA), dimethylaminoethyl acrylate (DMAEA) and dimethylaminopropylacrylamide (DMAPAA) are exemplified.

As the amide group-containing monomer, for example, (meth) acrylamide, N-methyl (Meth) acrylamide, N-ethyl (meth) acrylamide, N-propyl (meth) acrylamide, N-hexyl (Meth) acrylamide, N, N-dimethylacrylamide (DMAA), N, N-diethylacrylamide (DEAA), N-isopropylacrylamide (NIPAM), diacetone acrylamide (DAAM), vinyl caprolactam, acryloyl morpholine, and vinylpyrrolidone are exemplified.

As the cyano group-containing monomer, for example, cyano (meth) acrylate, (meth) acrylonitrile are exemplified. As the thiol group-containing monomer, a (meth) acrylic monomer having a thiol group in the side chain is exemplified. As the silyl group-containing monomer, a (meth) acrylic monomer having a silyl group in the side chain is exemplified.

One type of the second monomer may be used alone, or two or more types may be used in combination. The content of the second monomer is, for example, 1 mass % or more, preferably 1 mass % to 10 mass %, more preferably 2 mass % to 8 mass %, with respect to 100 parts by mass of the polymer.

In particular, when an amino group-containing monomer, an amide group-containing monomer, or a nitrogen-based heterocyclic ring-containing monomer among the second monomers are used in combination, the blending amount of the amino group-containing monomer, the amide group-containing monomer, or the nitrogen-based heterocyclic ring-containing monomer may be, for example, 0.01 mass % or more, preferably 0.01 mass % to 2.0 mass %, more preferably 0.2 mass % to 2.0 mass %, with respect to 100 parts by mass of the polymer.

### Other Monomers

The above monomer mixture may include other monomers that do not fall under the definition of the first or the second monomer described above. As the other monomers, (meth) acrylic acid esters are mainly used, but other copolymerizable monomers and the like can be further used. In addition, as the other monomers, two or more of these may be used in combination.

### (Meth) Acrylic Acid Ester

As the (meth) acrylic acid ester, for example, an alkyl (meth) acrylate, an alkoxyalkyl (meth) acrylate, an alkoxypolyalkylene glycol mono (meth) acrylate, an alicyclic group or aromatic ring-containing (meth) acrylate are exemplified.

The carbon number of the alkyl group in the alkyl (meth) acrylate is preferably 1 to 20. As the alkyl (meth) acrylate, for example, methyl (meth) acrylate, ethyl (meth) acrylate, n-propyl (meth) acrylate, iso-propyl (meth) acrylate, n-butyl (meth) acrylate, iso-butyl (meth) acrylate, tert-butyl (meth) acrylate, pentyl (meth) acrylate, hexyl (meth) acrylate, heptyl (meth) acrylate, 2-ethylhexyl (meth) acrylate, octyl (meth) acrylate, nonyl (meth) acrylate, decyl (meth) acrylate, undecyl (meth) acrylate, dodecyl (meth) acrylate, lauryl (meth) acrylate, oleyl (meth) acrylate, n-stearyl (meth) acrylate, iso-stearyl (meth) acrylate are exemplified.

As the alkoxyalkyl (meth) acrylate, for example, methoxymethyl (meth) acrylate, 2-methoxyethyl (meth) acrylate, 2-ethoxyethyl (meth) acrylate, 3-methoxypropyl (meth) acrylate, 3-ethoxypropyl (meth) acrylate, 4-methoxybutyl (meth) acrylate, and 4-ethoxybutyl (meth) acrylate are exemplified.

As the alkoxypolyalkylene glycol mono (meth) acrylate, for example, methoxydiethylene glycol mono (meth) acrylate, methoxydipropylene glycol mono (meth) acrylate, ethoxytriethylene glycol mono (meth) acrylate, ethoxydiethylene glycol mono (meth) acrylate, and methoxytriethylene glycol mono (meth) acrylate are exemplified.

As the alicyclic group or aromatic ring-containing (meth) acrylate, for example, cyclohexyl (meth) acrylate, benzyl (meth) acrylate, phenyl (meth) acrylate, isobornyl (meth) acrylate, and phenoxyethyl (meth) acrylate are exemplified.

### Copolymerizable Monomer

As the copolymerizable monomer, for example, styrene; alkylstyrene such as methylstyrene, dimethylstyrene, trimethylstyrene, propylstyrene, butylstyrene, hexylstyrene, heptylstyrene and octylstyrene and the like; styrene-based monomer such as fluorostyrene, chlorostyrene, bromostyrene, dibromo styrene, iodostyrene, nitrostyrene, acetylstyrene and methoxystyrene and the like; and vinyl acetate are exemplified.

### Modified Polyolefin

As the modified polyolefin, those having any configuration can be used. For example, an acid-modified polyolefin can be used as the modified polyolefin. As the modified polyolefin, it is preferable to use a polyolefin containing a carboxylic acid, more preferably a carboxylic anhydride-modified polyolefin, and particularly preferably a maleic anhydride-modified polyolefin. As the polyolefin skeleton, those having a polyethylene or polypropylene structure are particularly preferable. It is to be noted that, when only unmodified polyolefin is used, the compatibility with the above polymer becomes insufficient.

The weight-average molecular weight (Mw) of the modified polyolefin measured by the GPC method is, for example, in the range of 10,000 to 300,000, preferably in the range of 20,000 to 200,000, and further preferably in the range of 50,000 to 100,000.

One type of the modified polyolefin may be used alone, or two or more types may be used in combination. The blending amount of the modified polyolefin is, for example, 5 parts by mass to 50 parts by mass, preferably 6 parts by mass to 40 parts by mass, more preferably 7 parts by mass to 30 parts by mass, with respect to 100 parts by mass of the polymer described above.

### Other Components

The adhesive composition may further contain a tackifier resin, a crosslinking agent, a silane coupling agent, an antistatic agent, an organic solvent, an antioxidant, a photostabilizer, a metal corrosion inhibitor, a plasticizer, a crosslinking promoter, nanoparticles and the like as other components.

### Tackifier Resin

As mentioned above, the adhesive composition according to the present disclosure can exhibit good adhesion performance even against a low-polarity adherend. Therefore, the adhesive composition according to the present disclosure may not necessarily contain a tackifier resin.

When a tackifier resin is used, it is preferable to use a rosin ester resin as the tackifier resin, and it is more preferable to use a polymerized rosin ester resin as the tackifier resin. As the rosin ester resin, for example, KE 311 (light colored rosin tackifier resin, manufactured by Arakawa Chemical Industries, Ltd.), FK 100 (stabilized rosin ester resin, manufactured by Harima Chemicals Group, Inc.), and PCJ (polymerized rosin ester resin, manufactured by Harima Chemicals Group, Inc.) are exemplified.

An aromatic tackifier resin may be used as the tackifier resin. As the aromatic tackifier resin, for example, an aromatic petroleum resin, a styrene-based polymer, a α-methyl styrene-based polymer, a styrene-(α-methyl styrene)-based copolymer, a styrene-aliphatic hydrocarbon-based copolymer, a styrene-(α-methyl styrene)-aliphatic hydrocarbon-based copolymer and a styrene-aromatic hydrocarbon-based copolymer are exemplified. Further, a terpene-based tackifier resin or a hydrogenated alicyclic hydrocarbon resin may be used as the tackifier resin.

One type of tackifier resin may be used, or two or more types may be used in combination. When a tackifier resin is used, the total content of the tackifier resin in the adhesive composition is, for example, 1 to 50 parts by mass, preferably 5 to 35 parts by mass, more preferably 10 to 30 parts by mass, with respect to 100 parts by mass of the polymer described above.

### Crosslinking Agent

As the crosslinking agent, an isocyanate-based compound, an epoxy-based compound, a metal chelate-based compound and the like are exemplified.

As the isocyanate-based compound, an isocyanate compound having two or more isocyanate groups in one molecule is usually used. As the isocyanate compound, for example, an aliphatic diisocyanate, an alicyclic diisocyanate, an aromatic diisocyanate are exemplified. As the aliphatic diisocyanate, aliphatic diisocyanates having a carbon number of 4 to 30, such as ethylene diisocyanate, tetramethylene diisocyanate, pentamethylene diisocyanate, hexamethylene diisocyanate, 2-methyl-1,5-pentane diisocyanate, 3-methyl-1,5-pentane diisocyanate, 2,2,4-trimethyl-1,6-hexamethylene diisocyanate and the like are exemplified. As the alicyclic diisocyanate, alicyclic diisocyanates with a carbon number of 7 to 30, such as isophorone diisocyanate, cyclopentyl diisocyanate, cyclohexyl diisocyanate, hydrogenated xylylene diisocyanate, hydrogenated tolylene diisocyanate, hydrogenated diphenylmethane diisocyanate, hydrogenated tetramethyl xylene diisocyanate and the like are exemplified. As the aromatic diisocyanate, aromatic diisocyanates with a carbon number of 8 to 30, such as phenylene diisocyanate, tolylene diisocyanate, xylylene diisocyanate, naphthylene diisocyanate, diphenyl ether diisocyanate, diphenylmethane diisocyanate, diphenylpropane diisocyanate and the like are exemplified.

As the isocyanate compound having three or more isocyanate groups in one molecule, for example, an aromatic polyisocyanate, an aliphatic polyisocyanate, and an alicyclic polyisocyanate are exemplified. Specifically, 2,4,6-triisocyanate toluene, 1,3,5-triisocyanate benzene, and 4,4′,4″-triphenylmethane triisocyanate are exemplified. Further, as the isocyanate compound, for example, trimer of diphenylmethane diisocyanate, polymethylene polyphenyl polyisocyanate, biuret or isocyanurate of hexamethylene diisocyanate or tolylene diisocyanate, a reaction product of trimethylol propane with tolylene diisocyanate or xylylene diisocyanate (for example, a three-molecule adduct of tolylene diisocyanate or xylylene diisocyanate), a reaction product of trimethylol propane with hexamethylene diisocyanate (for example, a three-molecule adduct of hexamethylene diisocyanate), polyether polyisocyanate, and polyester polyisocyanate are exemplified.

As the epoxy-based compound, for example, an epoxy compound having two or more epoxy groups in one molecule is usually used. For example, ethylene glycol diglycidyl ether, polyethylene glycol diglycidyl ether, glycerin diglycidyl ether, glycerin triglycidyl ether, 1,3-bis (N, N-diglycidylaminomethyl) cyclohexane, N,N,N′,N′-tetraglycidyl-m-xylylenediamine, N,N,N′,N′-tetraglycidylaminophenylmethane, triglycidyl isocyanurate, m-N, N-diglycidyl aminophenyl glycidyl ether, N, N-diglycidyl toluidine, N, N-diglycidyl aniline are exemplified.

As the metal chelate compound, for example, compounds in which alkoxide, acetylacetone, ethyl acetoacetate, and the like are coordinated with a polyvalent metal such as aluminum, iron, copper, zinc, tin, titanium, nickel, antimony, magnesium, vanadium, chromium, and zirconium and the like are exemplified. Specifically, aluminium isopropylate, aluminium secondary butyrate, aluminium ethylacetoacetate diisopropylate, aluminium trisethylacetoacetate, aluminium trisacetylacetonate are exemplified.

As the crosslinking agent, a type that can react with the crosslinkable functional group in the monomer containing a crosslinkable functional group of the present disclosure can be appropriately selected. For example, when the crosslinkable functional group is a carboxy group, an epoxy-based compound is preferable, and when the crosslinkable functional group is a hydroxyl group, an isocyanate-based compound is preferable from the viewpoint of providing good durability and stress-relaxation.

The crosslinking agent is in a range of 0.01 to 5 parts by mass, preferably 0.01 to 2 parts by mass, further preferably 0.01 to 1 part by mass, with respect to 100 parts by mass in total with the polymer described above. When the crosslinking agent is contained in this range, the durability and the stress relaxation can be balanced.

### Silane Coupling Agent

The silane coupling agent firmly adheres the adhesive layer to an adherend such as a glass substrate, can prevent peeling of the adhesive layer in a high-humidity and heat environment, and has a large effect of improving durability when combined with the above-mentioned polymer.

As the silane coupling agent, for example, a polymerizable unsaturated group-containing silane coupling agent such as vinyltrimethoxysilane, vinyltriethoxysilane, methacryloxypropyltrimethoxysilane and the like; an epoxy-containing silane coupling agent such as 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl) ethyltrimethoxysilane and the like; an amino group-containing silane coupling agent such as 3-aminopropyltrimethoxysilane, N-(2-aminoethyl)-3-aminopropyltrimethoxysilane, N-(2-aminoethyl)-3-aminopropylmethyldimethoxysilane and the like; and a halogen-containing silane coupling agent such as 3-chloropropyl trimethoxysilane and the like are exemplified.

Among these, the epoxy-containing silane coupling agent is preferable in terms of stress-relaxation and the like. In the composition of the present disclosure, the content of the silane coupling agent is usually 1 part by mass or less, preferably 0.01 to 1 part by mass, more preferably 0.05 to 0.5 part by mass, with respect to 100 parts by mass of the above polymer. When the content is in the above range, peeling of the adhesive layer in a high-humidity and heat environment and bleeding of the silane coupling agent in a high-temperature environment tend to be prevented.

### Antistatic Agent

As the antistatic agent, for example, a surfactant, an ionic compound, and a conductive polymer are exemplified.

As the surfactant, for example, quarternary ammonium salts, amide quarternary ammonium salts, pyridium salts, cationic surfactants having a cationic group such as primary to tertiary amino groups and the like; anionic surfactants having an anionic group such as a sulfonate group, a sulfate group, a phosphate group and the like; amphoteric surfactants such as alkyl betaines, alkyl imidazolinium betaines, alkyl amine oxides, amino acid sulphuric esters; nonionic surfactants such as glycerin fatty acid esters, sorbitan fatty acid esters, polyoxyethylene alkylamines, polyoxyethylene alkylamine fatty acid esters, N-hydroxyethyl-N-2-hydroxyalkylamines, alkyldiethanolamides and the like are exemplified.

Further, a reactive emulsifier having a polymerizable group can also be exemplified as the surfactant, and a polymer-based surfactant obtained by increasing the molecular weight of a monomer component containing the above surfactant or the reactive emulsifier can also be used.

The ionic compound is composed of a cation part and an anion part, and may be either solid or liquid at room temperature (23° C./50% RH).

As the ionic compound, lithium bis (trifluoromethanesulfonyl) imide, lithium bis (difluorosulfonyl) imide, lithium tris (trifluoromethanesulfonyl)methane, potassium bis (trifluoromethanesulfonyl) imide, potassium bis (difluorosulfonyl) imide, 1-ethylpyridinium hexafluorophosphate, 1-butylpyridinium hexafluorophosphate, 1-hexyl-4-methylpyridinium hexafluorophosphate, 1-octyl-4-methylpyridinium hexafluorophosphate, 1-octyl-4-methylpyridinium bis (fluorosulfonyl) imide, 1-octyl-4-methylpyridinium bis (trifluoromethanesulfonyl) imide, (N,N-diethyl-N-methyl-N-(2-methoxyethyl) ammonium tetrafluoroborate, N,N-diethyl-N-methyl-N-(2-methoxyethyl) ammonium bis (trifluoromethanesulfonyl) imide, 1-octylpyridinium fluorosulfonium imide, 1-octyl-3-methylpyridinium, trifluorosulfonium imide are preferable.

As the conductive polymer, for example, polythiophene, polyaniline, polypyrrole and derivatives thereof are exemplified.

In the composition of the present disclosure, the content of the antistatic agent is usually 3 parts by mass or less, preferably 0.01 to 3 parts by mass, more preferably 0.05 to 2.5 parts by mass with respect to 100 parts by mass of the above polymer.

### Organic Solvent

The adhesive composition according to the present disclosure may not necessarily contain a solvent, but may contain an organic solvent in order to adjust its coatability. In the adhesive composition according to one aspect of the present disclosure, the content of the organic solvent is usually 50 to 90 mass %, preferably 60 to 85 mass %. It is to be noted that, in the present specification, “solid content” refers to all components except the organic solvent among the components contained in the adhesive composition, and “solid content concentration” refers to the ratio of the solid content with respect to 100 mass % of the adhesive composition.

There is no restriction on the application of adhesive composition according to the present disclosure. The adhesive composition according to one aspect of the present disclosure is used, for example, in automotive manufacturing and building material applications.

### Adhesive

The adhesive according to the present disclosure is formed by the adhesive composition described above. Although the gel fraction of this adhesive is not particularly limited, it is usually 80 mass % or less.

### Adhesive Sheet

The adhesive sheet according to the present disclosure includes: a double-sided adhesive sheet having only an adhesive layer formed on a covering film (hereinafter, also referred to as a separator) that has been subjected to a peeling treatment; a double-sided adhesive sheet having a substrate and the above-mentioned adhesive layer formed on both sides of the substrate (in this case, the substrate is also referred to as a core material); a single-sided adhesive sheet having a substrate and the above-mentioned adhesive layer formed on one side of the substrate; and an adhesive sheet in which a covering film that has been subjected to a peeling treatment is attached to the side of the adhesive layer of the adhesive sheet that is not in contact with the substrate.

As the substrate and covering film, for example, a polyester film such as polyethylene terephthalate (PET) and the like, a polyolefin film such as polycarbonate, polyethylene, polypropylene, ethylene-vinyl acetate copolymer and the like, a plastic film such as a polarizing plate, a phase difference film, a light diffusion film, and a brightness improving film, and glass are exemplified. Further, as the plastic film and the glass, those obtained by laminating various additives and a plurality of layers can be used. In particular, various woven or non-woven fabrics may be used as the substrate. It is to be noted that, in the present disclosure, when a low-polarity adherend such as polyolefin-based adherend is used as the substrate, for example, even in the case where the substrate includes polyolefin, the adhesive composition according to the present disclosure also has a good adhesive property to the substrate, so the choice of substrates to be used is not narrowed.

As the method of applying the adhesive composition, a method of applying and drying so as to have a predetermined thickness by a known method, for example, a spin coating method, knife coating method, roll coating method, bar coating method, blade coating method, die coating method, gravure coating method can be used.

### EXAMPLES

Hereinafter, the present disclosure will be described more specifically based on Examples, but the present disclosure is not limited to these Examples. In the following description of Examples, “parts” means “parts by mass” unless otherwise specified.

### Mw, Mn

The weight average molecular weight (Mw) and the number average molecular weight (Mn) of the polymer were determined by gel permeation chromatography (GPC) under the following conditions.

Measurement equipment: HLC-8320 GPC (made by Tosoh)

GPC column configuration: the following Four-column (all made by Tosoh)
(1) TSKgel HxL-H (guard column)

### (2) TSKgel GMHxL

### (3) TSKgel GMHxL

### (4) TSKgel G2500HxL

Flow rate: 1.0 mL/min

Column temperature: 40° C.

Sample concentration: 1.5% (w/v) (diluted with tetrahydrofuran)

Mobile phase solvent: Tetrahydrofuran

Standard polystyrene conversion

### Synthesis of Polymers

### Synthesis Examples 1 to 8

In a reactor equipped with an agitator, a reflux condenser, a thermometer and a nitrogen introduction tube, methoxyethyl acrylate (MEA), methyl acrylate (MA), ethoxydiethylene glycol acrylate (Viscoat V #190), acrylic acid (AA), dimethylaminoethyl methacrylate (DMAEMA;DM), dimethylaminopropylacrylamide (DMAPAA), n-butyl acrylate (BA), 2-ethylhexyl acrylate (2EHA), and 2-hydroxyethyl acrylate (2HEA) were mixed at the ratio (parts by mass) shown in Table 2, and 100 parts of ethyl acetate was added, and the temperature was raised to 80° C. while introducing nitrogen gas. Then, 0.1 part of tert-butyl peroxypivalate was added, and a polymerization reaction was carried out at 80° C. for 6 hours under a nitrogen gas atmosphere. After completion of the reaction, the mixture was diluted with ethyl acetate to prepare a polymer solution having a solid content concentration of 30 mass %. The properties of the obtained polymer are also shown in Table 2.

TABLE 2

| | | Synthesis Example | | | | | | |
|---|---|---|---|---|---|---|---|---|
| | | Synthesis | Synthesis | Synthesis | Synthesis | Synthesis | Synthesis | Synthesis |
| | | Example 1 | Example 2 | Example 3 | Example 4 | Example 5 | Example 6 | Example 7 |
| Polymer | | Polymer 1 | Polymer 2 | Polymer 3 | Polymer 4 | Polymer 5 | Polymer 6 | Polymer 7 |
| First monomer | MEA | 94.5 | 50 | — | 10 | — | 94.5 | 96.5 |
| | MA | — | — | — | 15 | — | — | — |
| | V#190 | — | — | — | — | 74.5 | — | — |
| Second monomer | AA | 5 | 5 | 5 | 5 | 5 | 5 | — |
| | DM | 0.5 | 0.5 | 0.5 | 0.5 | — | — | — |
| | DMAPAA | — | — | — | — | — | 0.5 | 0.5 |
| The other monomer | BA | — | 44.5 | 84.5 | 69.5 | 20 | — | — |
| | 2EHA | — | — | 10 | — | — | — | — |
| | 2HEA | — | — | — | — | — | — | 3 |

| | | | | | | | |
|---|---|---|---|---|---|---|---|
| Solubility parameter (cal/cm³)^{0.5} | 10.35 | 10.15 | 9.93 | 10.14 | 10.00 | 10.52 | 10.28 |
| weight-average molecular weight (Mw) | 40 | 40 | 50 | 40 | 40 | 35 | 40 |

### Examples 1 to 8 and Comparative Examples 1 to 3

The polymers obtained in Synthesis Examples 1 to 7, the modified polyolefin, and the epoxy-based crosslinking agent or isocyanate-based crosslinking agent were mixed in the combinations and ratios shown in Table 3 below to obtain an adhesive composition. Maleic anhydride-modified polypropylene was used as the modified polyolefin. E50C (manufactured by Soken Chemical) was used as the epoxy-based crosslinking agent, and L45E (manufactured by Soken Chemical) was used as the isocyanate-based crosslinking agent.

Each of the obtained adhesive compositions was applied to a light-to-release film (Cerapeel MF: manufactured by TORAY ADVANCED FILM Co., Ltd.) so that the adhesive layer after drying had a thickness of 30 μm, dried, and then transferred to a PET film having a thickness of 25 μm (Lumirror: manufactured by TORAY INDUSTRIES, INC.). In this way, an adhesive layer was formed on the substrate and cured under a condition of 25° C./50% RH for 7 days to produce an adhesive sheet.

TABLE 3

| | | | | | | | | | Comparative | Comparative | Comparative |
|---|---|---|---|---|---|---|---|---|---|---|---|
| | Example 1 | Example 2 | Example 3 | Example 4 | Example 5 | Example 6 | Example 7 | Example 8 | Example 1 | Example 2 | Example 3 |
| Polymer | Polymer 1 | Polymer 2 | Polymer [symbol] | Polymer 2 | Polymer 4 | Polymer 5 | Polymer 6 | Polymer 7 | Polymer 1 | Polymer [symbol] | Polymer 3 |
| [symbol] | [symbol] | [symbol] | [symbol] | [symbol] | [symbol] | [symbol] | [symbol] | [symbol] | [symbol] | Not added | [symbol] |
| [symbol] | 0.05 | 0.04 | 0.08 | 0. [symbol] 6 | 0.03 | 0.06 | 0.06 | — | 0.08 | [symbol] | [symbol] |
| [symbol] | | | | | | | | [symbol] .18 | | | |
| [symbol] | 0.45 | 0.8 | 0.8 | 0.8 | 00.8 | 0.8 | 0.45 | 0.0 | unmeasurable | 30 [symbol] | 36 [symbol] |
| [symbol] | [symbol] | [symbol] | [symbol] | [symbol] | [symbol] | [symbol] | [symbol] | [symbol] | | [symbol] | [symbol] |
| [symbol] | [symbol] | [symbol] | [symbol] | [symbol] | [symbol] | [symbol] | [symbol] | [symbol] | | [symbol] | [symbol] |
| [symbol] | 2 [symbol] | 23 | 36 | 18 | 18 | 21 | 20 | 22 | | 4 [symbol] | 41 |
| [symbol] | [symbol] .8 | [symbol] | [symbol] | [symbol] | [symbol] | [symbol] | [symbol] | [symbol] | [symbol] | 0.3 | [symbol] |

[symbol]

indicates data missing or illegible when filed

### Holding Force

The holding force was measured in accordance with JIS Z 1541. The adhesive sheet was cut into a width of 20 mm, stuck to the PP (polypropylene) plate so that an area of 20×20 mm was in contact with the sheet, subjected to a 1 kg load at 80° C., and observed the presence or absence of falling when left for 1 hour. The results are also shown in Table 3 above. It is to be noted that, in Table 3, ↓ means that it has fallen.

### Adhesive Force

Using the adhesive sheet prepared in the above procedure, the exposed adhesive layer surface was pressure-bonded (stuck) to a PP plate using a 2 kg roller under a condition of 25° C./50% RH. After allowing it to stand for 20 minutes after sticking, the adhesive sheet was peeled off from the PP plate as a peeling rate of 300 mm/min under a condition of room temperature or during heating at a peeling angle of 180°, and the peel force (adhesive force) of the adhesive layer of the adhesive sheet was measured. In addition, the adhesive force during heating (vs. the adhesive force during heating of PP) was measured at the same temperature immediately after heating the adhesive sheet at 80° C. for one hour. The results are also shown in Table 3 above. It is to be noted that, in Table 3, the symbol of indicates that interfacial peeling has occurred, and cf indicates that cohesive failure has occurred.

### Liquid Paraffin Contact Angle

About 1 μl of a microdroplet was placed on the sample surface, and the measurement was performed in the air using a KYOWA CONTACT-ANGLE METER CA-D type manufactured by Kyowa Interface Science Co., Ltd. The measurement conditions were based on JISR3257.

### Haze

An adhesive sheet was produced in the same procedure as the adhesive sheet described above, except that it was transferred to a glass plate having a haze value of zero in place of the PET film having a thickness of 25 μm. In the measurement, the release film was peeled off, and the haze value of a test piece having only the adhesive layer on the glass plate was measured as the haze value of the adhesive layer. A haze meter (model name HM-150, manufactured by Murakami Color Research Laboratory) was used for the measurement.

### Analysis Results

As shown in Comparative Example 1, when an unmodified polyolefin was used, it was impossible to measure the adhesion performance because of insufficient compatibility. Further, as shown in Comparative Example 2, when the modified polyolefin was not used, the adhesion performance was insufficient. Furthermore, as shown in Comparative Example 3, when a polymer having a solubility parameter of less than 10.0 was used, the adhesion performance was insufficient. On the other hand, as shown in Examples 1 to 8, excellent adhesion performance could be achieved by using a polymer having a solubility parameter of 10.0 or more and a modified polyolefin in combination.

1. An adhesive composition, comprising:
a (meth) acrylic polymer having a solubility parameter of 10.0 (cal/cm³)^{0.5} or more according to Fedors method; and
a modified polyolefin.

2. The adhesive composition according to claim 1, wherein the (meth) acrylic polymer is obtained by copolymerizing a monomer mixture including a first monomer and a second monomer, the first monomer having a solubility parameter of 9.8 (cal/cm³)^{0.5} or more by the Fedors method at time of forming a homopolymer and containing no crosslinkable functional group, the second monomer containing a crosslinkable functional group.

3. The adhesive composition according to claim 2, wherein the second monomer contains nitrogen.

4. The adhesive composition according to claim 1, wherein the modified polyolefin is a polyolefin containing a carboxylic acid.

5. The adhesive composition according to claim 1, further comprising an epoxy-based curing agent.

6. An adhesive formed from the composition according to claim 1.

7. An adhesive sheet, comprising:
a substrate; and
an adhesive layer formed on at least one surface of the substrate by the adhesive composition according to claim 1.

8. The adhesive sheet according to claim 7, wherein the substrate comprises a polyolefin.
